(19) United States
(12) Patent Application Publication
(10) Pub. No.: US 2015/0356553 A1
(43) Pub. Date: Dec. 10, 2015

(54) SYSTEM FOR VERIFYING THE AUTHENTICITY OF A PAYMENT CARD HOLDER

(71) Applicants: Petr Fedorovich Kutis, (US); Payture Ltd., Tortola (VG)

(72) Inventors: Petr Fedorovich Kutis, Balashiha (RU); Roman Rafikovich Hafizov, Moscow (RU)

(21) Appl. No.: 14/430,940

(22) PCT Filed: Sep. 26, 2013
(86) PCT No.: PCT/RU2013/000839

§ 371 Date: Jun. 15, 2015

(30) Foreign Application Priority Data
Sep. 26, 2012 (RU) 2012141090

(51) Int. Cl. G06Q 20/38; G06Q 20/34

(52) U.S. Cl. CPC G06Q 20/38; G06Q 20/34

(57) ABSTRACT

The invention relates to the art of acquiring and can be used by an acquirer during the provision of merchant acquiring services in the event of an attempt to make a payment using a payment card without physical presence of the cardholder. The system makes it possible to establish authenticity of the cardholder in real time prior to execution of the payment by transmitting a testing signal to the cardholder through the issuer within the framework of a request for an operation to block a small amount of funds on the card. The signal is an alphanumeric code designating the merchant in whose favor the funds on the card are being blocked. This makes it possible to reduce the risk of fraud and avoid a subsequent dispute. The system is based on the obligation of all Issuers to follow a common standard for the exchange of data with payment systems in the course of operations using an international payment card, and the obligation of all Issuers to observe the confidentiality of operations carried out by cardholders and disclose payment information to cardholders alone with preliminary authentication of the latter.

### BACKGROUND OF THE INVENTION

The invention relates to the field of acquiring/purchasing/credit card payment processing, notably to the security of electronic payments carried out using payment cards of International Payment Systems (IPS) such as Visa, MasterCard, JCB International, American Express and others. This invention may be used for verifying the authentication of a payment card holder in the event of an attempt to carry out remote payment without personal presence. In this case we mean online payments on shops' websites and payment service providers, or payments made when ordering a service or goods over the phone, which recently become wide spread. In the latter case the payer, by means of voice, discloses data on his payment card in order to debit certain amounts in favor of the merchant for rendering, by the latter, a service or delivery of goods.

Remote processing of payment cards is conventionally performed through sending, by the payer, of basic card parameters to the issuer bank via merchant, assigner or on a direct basis. Card parameters are represented (in some cases embossed) on the card itself and on a magnetic strip on the card. Among these parameters is the card number, card validity period, special verification code and sometimes the name of the cardholder. Then this data is sent by the acquirer through IPS communications system to the issuer in the form of formalized messages in accordance with ISO 8583 protocol.

Upon receiving of the message, the issuer checks correctness of the data transmitted and, in case the card with the received data really exists and can be used for such operations, it transfers money from the card to the account maintained by issuer for the merchant. Thus, in order to make a payment it is sufficient to know card parameters, which allows to use different fraud schemes when the payer is not the cardholder but he/she knows its parameters (has peeked at the card, made a photo or temporarily has the card in his/her possession). The main problem of such fraud is the obligation of the purchaser (cardholder) to repay the amounts debited from the card in case of card transaction being disputed by its true holder, which significantly increases risks in the provision of acquiring services, including those where remote payments are involved.

Today IPS actively forces additional protection measures against fraud. It involves a 3-D

Secure authentication model, which allows to perform authentication of the payer on the secure website of the issuer. 3-D Secure is a XML-protocol, which is used as an additional level of security for online credit and debit cards, as well as for two-factor authentication of a card user. It was developed by Visa IPS to improve security of payments made via the Internet. On its basis. Visa offered to its client a service named Verified by Visa (VbV). Services based on this protocol were also accepted by MasterCard as MasterCard SecureCode (MCC) and by JCB International as J/Secure.

The protocol procedure is outlined in details in the document “3-D Secure system overview” see

https:**partnernetwork.visa.com/vpn/global/retrieve document.do?documentRetrievalId=119.
3-D Secure protocol is intended to perform the authentication of a cardholder by the issuer itself. For this purpose the issuer has to take additional measures for adjusting its hardware-software infrastructure in order to be able to use 3-D Secure.

The major and crucial disadvantages of 3-D Secure protocol are:

1) At the moment, more than half the issuers do not participate in 3-D secure authentication model or participate only partly. For this reason the issuer is not able to check the majority of cardholders, which reduces the efficiency of 3-D Secure protocol. The main reason why issuers do not participate in this model is that in case of successful authentication of a cardholder with 3-D Secure protocol, the issuer will assume responsibility for the possible fraud.

Heavy workload for the payer in the form of following from one web-page to another is another reason. This reduces the confidence of the payers for the merchant and their desire to make payments on the web-sites of the merchant. Generally speaking this fact affects the merchant in such a way that in order to keep its clients, the merchant avoids using 3-D Secure protocol. bearing all fraud risks by themselves. However in general such situation undermines the confidence in IPS products, which in its turn results in decreasing of cards' usage for electronic payments via the Internet that constitutes considerable proportion of payments in the world.

US 2011/0119155 discloses the system for verifying the authenticity of a payment card holder in remote access mode using 3-D Secure authentication model developed by Visa to improve security of payments made via the Internet. US 2011/0119155 describes a 3-D Secure application with the same structure and algorithm. which were outlined in the document “3-D Secure system overview”, cited above.

The disadvantage of US 2011/011915 is the complexity of the algorithm of interaction in the mode of cardholder authentication by the issuer itself. For this purpose, the issuer has to take additional measures for adjusting its hardware-software infrastructure in order to be able to use 3-D Secure protocol.

This system functions only when there is the relevant software on the computerized device of a cardholder, used for receiving requests and providing responses. However, this system involves not a single action (one request—one answer), but several requests, each of which is made on a certain page and demands an answer on another page. As a result, the cardholder has to hold a dialogue in the course of his/her authentication.

Introduction of the authentication algorithm accepted in the document “3-D Secure system overview” and repeated in US 2011/0119155 demands creation of such a system in which all its participants have to change their hardware-software infrastructures. At the real level, it is not only unsafe, but almost impossible, since changing of the existing structure of interaction between the cardholder, the hardware-software complex of the acquirer, the device via which data on this card are entered, the server for management the transactions flow between infrastructures of payment cards' issuers, infrastructure of cardholders and payment infrastructure, etc. undermines the possibility to carry out any transactions at all.

A conventional system for verifying the authenticity of a payment card holder is described in US 2010/0280946. In this system, prior to the payment, an authorization request is formed, in which a code unknown to the cardholder in advance is inserted, the authorization request is sent to the issuer, a verification code is requested from the cardholder and based on the correctness of the code sent by the holder the authenticity of this payment card holder is identified; the verification code is sent in a standard authorization request based on the fact that the access to the payment information of private individuals in banks is highly restricted, and in order to get access to this payment information, the issuer performs the authentication of the holder of the account (who is the cardholder); the code entered by the cardholder is received, and on the basis of the sent and received codes, the authenticity of the payment card holder is determined.

This system has a disadvantage in that the code request is performed through redirection of the cardholder to the web-page of the issuer, however, that the exact query parameter and code entering procedure is not mentioned in the patent. In this regard, the sufficient safety of payment operations performance using the card is not reached, as there is no separation of channels of transmitting payment information and the data confirming the payment and the lack of interchange between the acquirer and the cardholder for the purpose of his/her authenticity confirmation.

### SUMMARY OF THE INVENTION

The present invention provides a method and system for authentication of a credit card holder that substantially obviates one or several of the disadvantages of the related art.

The present invention improves safety of payment operations performance with the use of the card due to the separation of channels of transmitting payment information and the data confirming payment, as well as due to the additional interchange between the acquirer and the cardholder for the purpose of his/her authenticity confirmation.

The specified technical result is achieved in the following way: prior to the payment, an authorization request for a small sum is generated in the system for verifying the authenticity of a payment card holder, in which a code unknown to the cardholder in advance is inserted, the authorization request is sent to the issuer, the verification code is requested from the cardholder, and, based on the correctness of the code sent by the holder, the authenticity of this payment card holder is identified, the verification code is sent in a standard authorization request based on the fact that the access to the payment information of private individuals in banks is highly restricted, and, in order to get access to this payment information, the issuer performs the authentication of the holder of the account (who is the cardholder); the verification code is requested from the cardholder on the payment page without redirecting the cardholder to the issuer's web-site, the code entered by the cardholder is received, and, on the basis of the sent and received codes, the authenticity of the payment card holder is identified.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates an algorithm of a system verifying the authenticity of a payment card holder;

FIG. 2 shows a flow chart of the architecture of the system verifying the authenticity of a payment card holder;

FIG. 3 shows links of the system verifying the authenticity of a payment card holder on the basis of the flow chart of FIG. 2.

### DETAILED DESCRIPTION OF THE PREFERRED EMBODIMENTS

Reference will now be made in detail to the preferred embodiments of the present invention, examples of which are illustrated in the accompanying drawings.

According to the present invention, a system verifies the authentication of a cardholder.

The system allows the issuer itself to carry out the authentication of a cardholder, applying existing standards and practices of interaction between the acquirer, the issuer and the cardholder. In most cases this authentication does not require considerable efforts from the payer and, at the same time, allows the acquirer to verify the authentication of IPC (international payment card) holders independently from other partners, including the issuer.

The system verifying the authenticity of a payment card holder in remote access mode contains the hardware-software complex of the acquirer, designed with a possibility to accept payments by entering information on the payment card and data on the device through which this information on the card was entered, via the management server of transaction flow between infrastructures of payment cards' issuers, cardholder infrastructure and payment infrastructure, designed to send data on the payment card and device to the hardware-software complex of the issuers of payment cards for the authentication of the entered card number of the device and communication of the data corresponding to the information found on the payment card and the device to the server of the hardware-software complex of the acquirer, designed with a possibility to send to the payer, on the device via which the information on this card are entered, a request for confirmation of the payment card code identification and to receive, from the user, a query response with the data on payment card code identification, as well as to grant permission to make payment via the server of the hardware-software complex of the acquirer.

Tasks performed by such system are:

1) Acquirer can consistently perform the authentication of IPC holder at his/her attempting to make payment at the merchant.

2) Verification of the authentication of IPC holder shall be performed in real time prior to the debiting of amounts from his/her card in the course of payment, meaning that upon the receiving of a request for payment, the acquirer performs the authentication, which slightly increases duration of payment making procedure (such increase is insignificant and acceptable).

3) The authentication shall be performed with the help of already existing capabilities of IPS, the issuer and IPC holder himself/herself as follows:
IPS provides communication system for transmitting formalized messages to any IPC issuer which allows to influence the issuers' system for reliable signal transferring to this system;
any issuer follows accounts confidentiality practice and provides details on operations only to the holder of an account or to the IPC, except to exclude access to the signal for defrauders;
almost any issuer can clarify the state of an account in real time and on frequent occasions automatically informs about IPC account changes at the same time, specifying the changes which, at the request of IPS, shall contain the name (designation) of the merchant.

4) Acquirer can perform authentication of a cardholder of any issuer and any country, without regard to the payment currency, and card currency since for such authentication an alphanumerical code of the merchant is used.

5) Acquirer can use a composed function of automatic notification by the issuer of his/her IPC holders, which simplifies the process and increases a speed of signal receiving by the IPC holder.

6) Application of the system needs no additional changes in hardware-software complex of the issuer and IPS; it also does not require any additional navigation of the payer to the web-sites of issuers and payment systems. One only needs to enter the signal value in the additional filed on IPC data entry page.

In the course of interoperability of systems of acquirer and issuer the system allows to transmit “A” (acquirer) signal, including an alphanumeric code (the code is known only to the acquirer) from the acquirer to IPC holder. Upon transmitting “A” signal, the acquirer makes a request to the payer for “H” (holder) signal transmitting, which is expected to be received by the issuer. The result of system action is the difference between the sent and received signals on the side of the Acquirer. If the payer transmits “H” signal value corresponding with “A” signal value, the authentication of IPC holder is considered successful and the risk of operation is seen as minimal. Otherwise the authentication is considered to be unsuccessful, IPC holder is identified as unverified and the risk of operation is high.

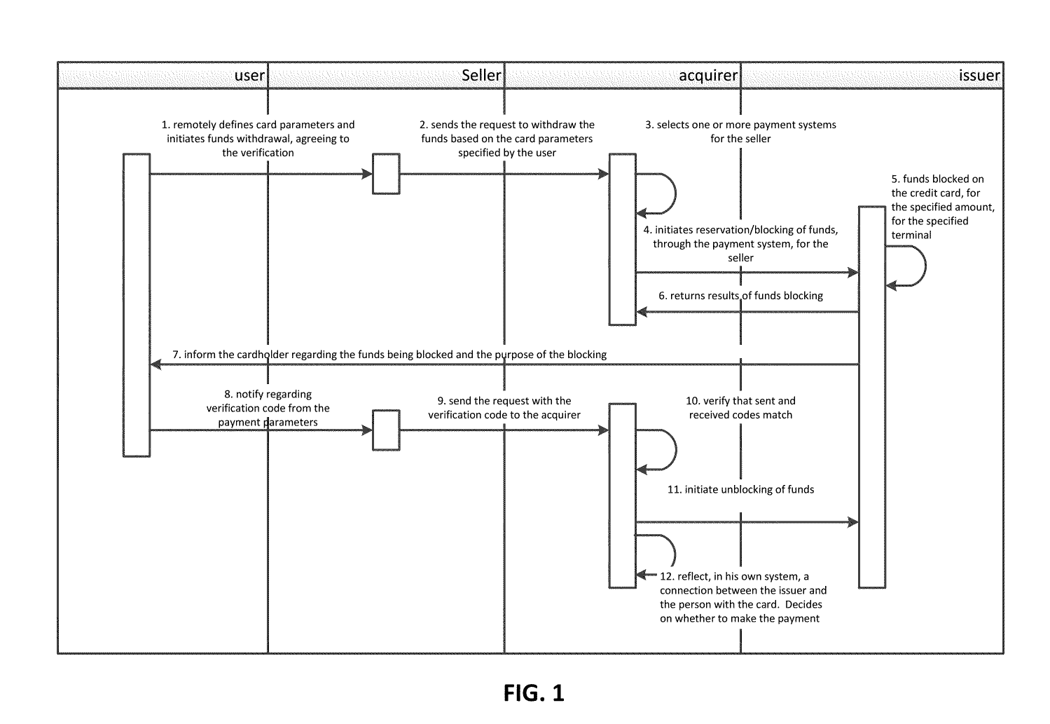

In more detail, this system can be implemented as follows (FIG. 1).

1) Upon receiving a request for making payment from the merchant, the hardware-software complex (hereinafter referred to as the “system”) of the acquirer influences the system of the issuer in real time. This influence consists of sending, to the system of the issuer, a formalized data flow, resulting in pre-authorization (blocking of funds on IPC) for a certain known small amount. In this case, the card information which was entered by the payer at the attempt to make payment is used. Such influence results in changes in the issuer's system upon which the system holds the IPC account change. In the course of data flow, a direction in the mandatory field of the flow providing for indication of merchant's code in favor of which funds are blocked, the system of the acquirer indicates “A” signal in the form of a short (no more than 10 characters) alphanumeric sequence indicating the code of one of several merchants preregistered in IPS. The number of merchants may be any, and it is recommended to use from 50 to 100 of them. Merchants are selected using any random number generator.

2) Then the system of the acquirer informs the payer that he/she has to identify “A” signal of the issuer as a part of the parameter indicating the code of the merchant in favor of which the funds on his/her card were blocked and report it to the acquirer as a part of “H” signal. The issuer alone provides secure authentication of IPC holder and reveals to him information about changes on IPC account where there is a hidden “A” signal.

3) Then the payer transmits to the acquirer “H” signal. The acquirer compares values of “A” and “H” signals and receives information on IPC holder authentication. If these signals have matched, the decision of IPC holder authentication is taken, i.e., the payer is the IPC holder and the acquirer requests an operation of debiting a certain amount under the payment requested by the merchant. If these signals have not matched, the decision is made on a high risk of fraud. In such case the acquirer has a right to deny the payment making requested by the merchant for the IPC, the parameters of which were specified by the payer.

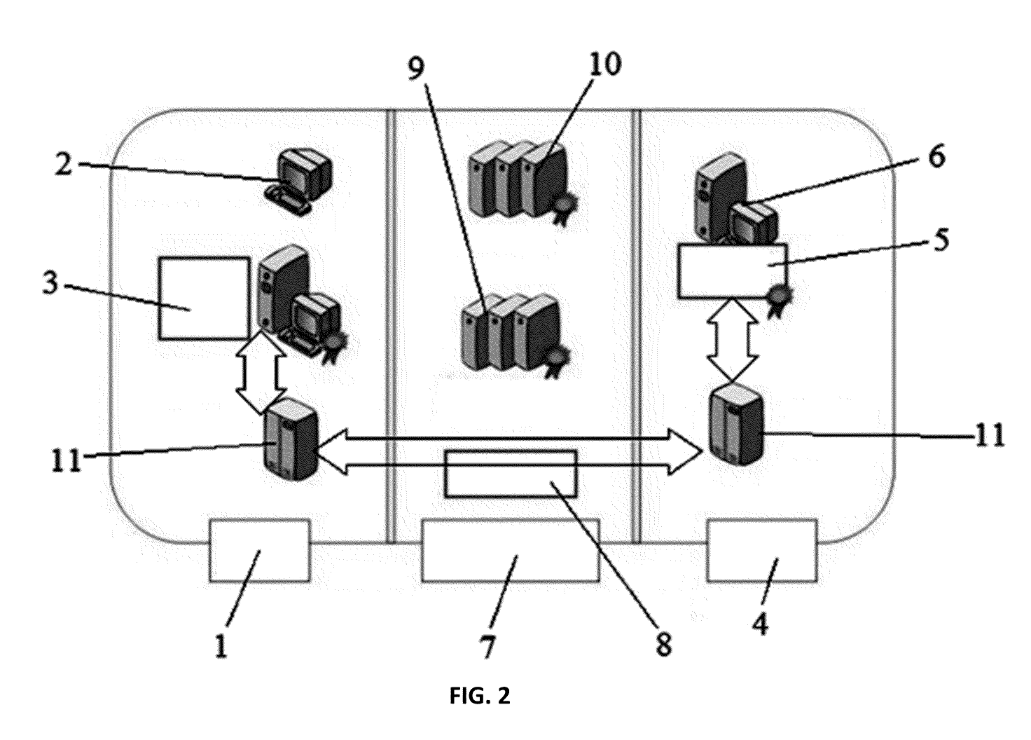

System algorithm is shown schematically in FIG. 1. In FIG. 2, the structural architecture of this system functioning under 3-D Secure protocol is shown. 3-D Secure model is implemented on the bases of three domains in which the initiation and verification of transactions is performed. Domain 1 of the Issuer includes the cardholder 2 and the issuing bank 3. Domain 4 of the Acquirer includes the acquirer bank 5 (MPI) and the merchant 6. Domain 7 of interaction contains elements that make it possible to conduct transactions between two other domains. It mainly includes networks 8, services 9, 10 IPS and communication units 11 (network connections).

Domains 1, 4 and 7 are independent and make an important part of data transmission process in the general 3-D Secure infrastructure. Each domain has its own line of responsibility in the process of performing transactions. In domain 1 of the Issuer the issuing bank 3 is responsible for the authentication of a payer and providing true information for transaction acceptance. In domain 2 of the Acquirer the merchant 6 is responsible for commercial relations with the payer and shall guarantee that the payer was sent to the correct issuing bank 3 for verification. In the same domain, the Acquirer is responsible for the coordination of transaction acceptance via IPS Visa or MasterCard. In domain 7 of interaction, IPS Visa or MasterCard is responsible for information integrity on each issuer (cardholder bank, Internet address of the issuer) and provision of this information for decision making in case of a conflict.

3-D Secure model provides a standard communication protocol between the domains for transactions exchange and verification. It does not require any changes in a relationship between the participants of one domain. The merchant and the Acquirer are free to choose any method of transaction execution and to manage relationships in their domains in any appropriate way. The Issuers are free to choose any mechanisms for cardholder authentication.

In 3-D Secure architecture a set of special servers for transaction flow servicing during its lifecycle is implemented (FIG. 2):
In domain 1 of the Issuer the Access Control Server (ACS) is responsible for managing authentication processes between the Buyer and the Issuer and ensures acceptance of payment transactions for the Merchant.
In domain 4 of the Acquirer the Merchant Plug-In (MPI) server manages transaction flow between Visa/MasterCard infrastructures, the infrastructure of a cardholder and payment infrastructure created by the Acquirer.
In domain 7 of interaction Visa/MasterCard Directory Server keeps information on workflow participants. In the same domain Visa/MasterCard Authentication History Server (AHS) securely stores information on all transactions and ensures its availability in conflict situations.
In domains of the Issuer and the Acquirer Host, systems are involved in the transactions regulation process in the back-office of the bank in order to ensure clearing offsets between the participants for the purpose of further transferring of funds. In accordance with 3-D Secure protocol issuers bear responsibility for the authentication of cardholders.

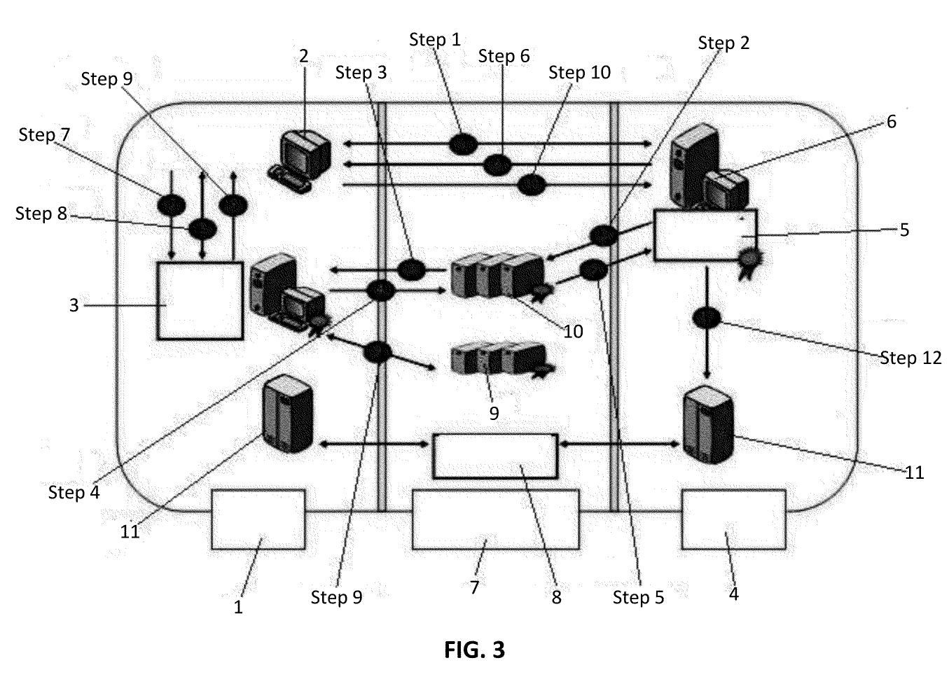

FIG. 3 shows the algorithm of interfacing in the system by demonstrating the steps for transmitting information on a transaction in case of online payment.

Step 1. A payer selects a relevant page on the web-site of the merchant 6 and enters information required for payment arrangement.

Step 2. MPI sends Transaction Verification Request (VeReq) with a card number (and information of the type of device, if any) to IPS.

Step 3. IPS finds the corresponding ACS of the card issuer and determines whether it is possible to perform the authentication for this card number and the type of device.

Step 4. ACS checks whether this cardholder is subscribed for 3-D Secure service and transfers the result to IPS.

Step 5. Directory Server returns ACS response to MPI.

Step 6. MPI sends Transaction Verification Request (PAReq) to ACS through the device of the Payer.

Step 7. ACS receives PAReq.

Step 8. ACS performs the authentication of the Payer by means of procedures, applicable for this card number (password, chip, PIN etc.). Then ACS creates a reply message (PARes) and signs it.

Step 9. ACS returns PARes to MPI through the device of the Payer. ACS also sends relevant data to Authentication History Server (AHS).

Step 10. MPI receives PARes.

Step 11. MPI checks the signature of PARes (either by performing the verification by itself or redirecting messages to separate Validation Servers) (on FIG. 3 this step is not shown).

Step 12. The merchant proceeds to the payment performance through the Acquirer.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A system for verifying authenticity of a payment card holder in a remote access
mode comprising:
a hardware-software complex of the acquirer for accepting payments by entering information regarding a payment card and information regarding a device through which the information regarding the payment card was entered;
a management server for managing transaction flow between infrastructures of payment cards' issuers, cardholder infrastructure and payment infrastructure,
wherein the management server sends the information regarding the payment card and the device to the hardware-software complex of the issuers of payment cards for authentication of an entered card number and identification of the device, and
the management server communicates the information regarding the payment card and the device, including a result of authentication received from the hardware-software complex of the issuers, to a server of the hardware-software complex of the acquirer,
wherein the server of the hardware-software complex of the acquirer sends, to the user, via the device through which the information on the payment card is entered, a request for confirmation of the payment card code identification, and
wherein the server of the hardware-software complex of the acquirer receives, from the user, a query response with the data on payment card code identification and grants permission to make a payment via the server of the hardware-software complex of the acquirer.
